(19) United States
(12) Patent Application Publication
(10) Pub. No.: US 2012/0053736 A1
(43) Pub. Date: Mar. 1, 2012

(54) Solid state control system

(76) Inventors: Christopher Cantolino, Bradenton, FL (US); Mark Oudshoorn, Parrish, FL (US); Robert Dean Sells, Palmetto, FL (US)

(21) Appl. No.: 12/931,130

(22) Filed: Jan. 25, 2011

Related U.S. Application Data
(63) Continuation-in-part of application No. 12/806,977, filed on Aug. 25, 2010.

(51) Int. Cl. F25D 21/02; G08B 21/00; G05D 23/19; F25D 21/14

(52) U.S. Cl. 700/276; 62/150; 340/636.1

(57) ABSTRACT

A control system to selectively control the operation of the compressor of an air conditioning system including at least one remote evaporator operatively coupled to the compressor to receive refrigerant therethrough, an air handler control system including a fault sensor to monitor the operation of the remote evaporator and to selectively generate a fault signal, and logic or circuitry to receive the fault signal from the fault sensor and to generate a fault control signal fed to the compressor to turn-off the compressor when a predetermined operating condition exists at the remote evaporator and a condensate drain pan to collect condensate from the remote evaporator, the control system comprising a condensate sensor disposed to sense condensate in the condensate drain pan at a predetermined level and to generate a condensate level signal fed to a control device coupled between the condensate sensor and the fault sensor of the air handler control system including logic or circuitry to generate a condensate level control signal in response to the condensate level signal and fed to the fault sensor to generate the fault signal causing the air handling control system to generate the fault control signal to turn-off the compressor when condensate within the condensate drain pan reaches the predetermined level.

### CROSS-REFERENCE

This is a continuation-in-part application of co-pending patent application Ser. No. 12/806,977 filed Aug. 25, 2010.

### BACKGROUND OF THE INVENTION

1. Field of the Invention

A control system to selectively control the operation of the compressor of an air conditioning system with a remote evaporator.

2. Description of the Prior Art

Air handling systems such as air conditioning systems typically have a condensate drain pan to collect condensate.

Often removal of the condensate requires pumping the condensate from the condensation drain pan. Commonly, a drain pan system includes a sensor placed in the drain pan to measure the level of the condensation therein. When the condensate level reaches a predetermined level, the sensor generates a signal sent to a sensor switching circuit to activate the pump or stop operation of the compressor.

HVAC systems know as mini-split systems present a particularly troublesome challenge. Such systems comprise of two basic units—a compressor and multiple air handlers. The air handler is typically mounted on the wall in the space to be cooled. These air handlers are designed to be compact resulting in limited space for an overflow switch and condensate sensor. Specifically, systems use refrigerant lines together power and control wiring to connect the outdoor compressor to the individual indoor air handlers. The technology, developed in the 1950s, is called split-ductless or mini-split and is the primary method for conditioning spaces within a home or commercial building in countries around the world. These systems allow each space with an indoor air-handler unit to be controlled independently from other rooms, thus providing individualized comfort control within a home.

In such systems, the compressor is connected to existing house voltage and supplies voltage to the air handlers.

In addition, a communications link is used to coordinate the operation of the two basic units. As a result, any electronics that would utilize the power supply has the potential of disrupting the communication link. Thus, any effort to provide a condensate removal system would require an electrically isolated battery powered system.

In order to shut down the highly integrated electro-mechanical system, a condensate control system can be tapped into a commonly found thermistor used to measure the evaporator temperature forming part of mini-split control loop. As designed, if the thermistor is broken or indicates a bad reading the compressor is shut down. This thermistor can be used to open the circuit when excess condensate is sensed in the condensate drain pan to shut down the compressor.

### SUMMARY OF THE INVENTION

The present invention relates to a control system to selectively control the operation of the compressor of an air conditioning system that includes a compressor and at least one remote air handler.

The air handler includes an evaporator coupled in closed-loop fluid communication with the compressor by refrigerant lines or conduits and a condensate drain pan disposed to collect condensate from the remote evaporator. The air handler further includes an air handler control system to monitor the operating parameters of the remote evaporator. The air handler control system generates a fault control signal when a predetermined operating condition such as a threshold temperature exists in the remote evaporator fed to the air conditioning system to stop or turn-off the compressor.

The control system comprises a condensate sensor disposed to sense when condensate within the condensate drain pan reaches a predetermined level and a control device to generate a condensate level control signal operatively coupled between the condensate sensor and the air handler control system to feed the condensate level control signal to the air handler control system to generate the fault control signal to turn-off the compressor when the condensate reaches the predetermined level.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a block diagram of the control system of the present invention in combination with an air conditioning system.

FIG. 2 is an exploded view of the control system of the present invention.

FIG. 3 is a detailed view of the coupling harness of the control system of the present invention.

FIG. 4 is a circuit diagram or schematic of the control system of the present invention.

FIG. 5 is a circuit diagram or schematic of an alternate embodiment of the control system of the present invention.

FIG. 6 is a detailed view of an alternate embodiment of the coupling harness of the control system of the present invention.

Similar reference characters refer to similar parts throughout the several views of the drawings.

### DETAILED DESCRIPTION OF THE PREFERRED EMBODIMENT

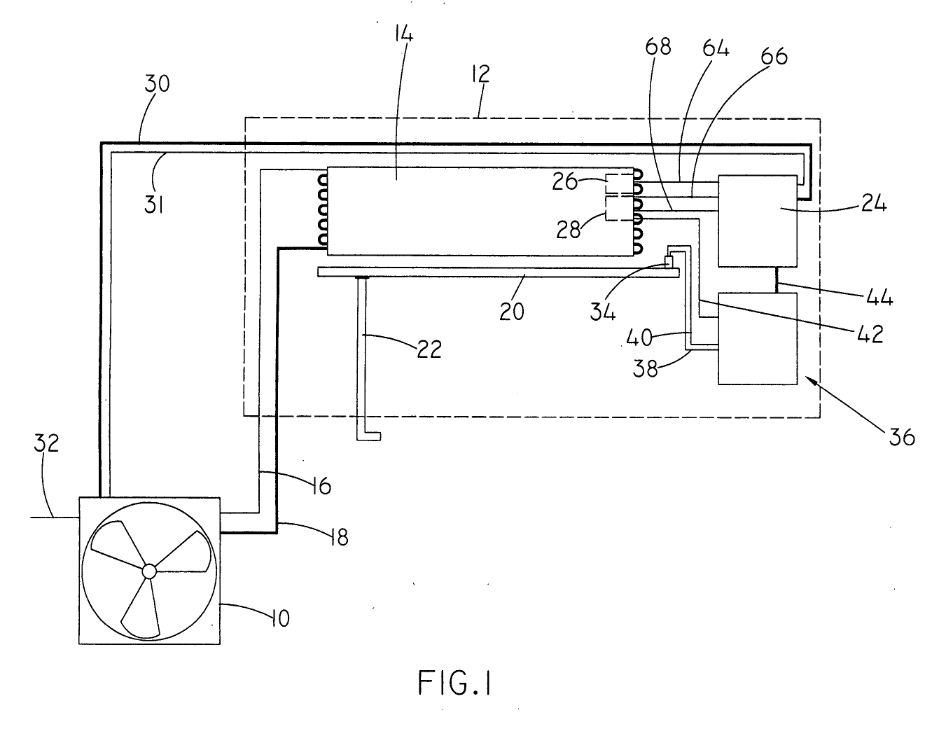

The present invention relates to a control system to selectively control the operation of the compressor of an air conditioning system that includes a compressor and at least one remote air handler shown as 10 and 12 respectively in FIG. 1.

As shown in FIG. 1, the air handler 12 includes an evaporator 14 coupled in closed-loop fluid communication with the compressor 10 by refrigerant lines or conduits 16 and 18, a condensate drain pan 20 disposed to collect condensate from the evaporator 14 and a condensate drain 22 to direct or carry condensate from the condensate drain pan 14 to a collection or run-off site (not shown). The air handler 12 further includes an air handler control system 24 coupled to multiple or independent redundant fault sensors or thermistors 26 and 28 disposed in heat exchange relationship relative to the evaporator 14. The fault sensors or thermistors 26 and 28 are coupled to the air handler control system 24 and a control device 36 as described hereinafter and ultimately to the compressor 10 by air handler power/communication conductor or line 30 and 31. When the fault sensors or thermistors 26 or 28 sense a predetermined operating condition such as a predetermined temperature the fault sensors or thermistors 26 and 28 generate a fault signal fed to the air handler control system 24 including logic or circuitry to generate a fault control signal in response to the fault signal to be fed over the air handler power/communication conductors or lines 30 or 31 to stop or turn-off the compressor 10 as described more fully hereinafter. The compressor is coupled to an external power source (not shown) by a power supply line or conductor 32.

As shown in FIG. 1, the control system of the present invention comprises a condensate sensor 34 disposed to sense when condensate collected in the condensate drain pan 20 reaches a predetermined level and to generate a condensate level signal and a control device or condensate level signal generator generally indicated as 36 including logic or circuitry to generate a condensate level control signal operatively coupled to the condensate sensor 34 by sensor signal or conductors or lines 38 and 40 to receive a condensate level signal therefrom and to generate the condensate level control signal in response thereto and coupled to the fault sensor or thermistor 28 by a control signal conductor 42 and to the air handler control system 24 of the air handler 14 by a conductor or line or 44 to feed the condensate level control signal to the fault sensor or thermistor 28 to control the operation of the fault sensor or thermistor 28, in response to the condensate level collected in the condensate drain pan 20 and, in turn, the compressor 10 as described more fully hereunder.

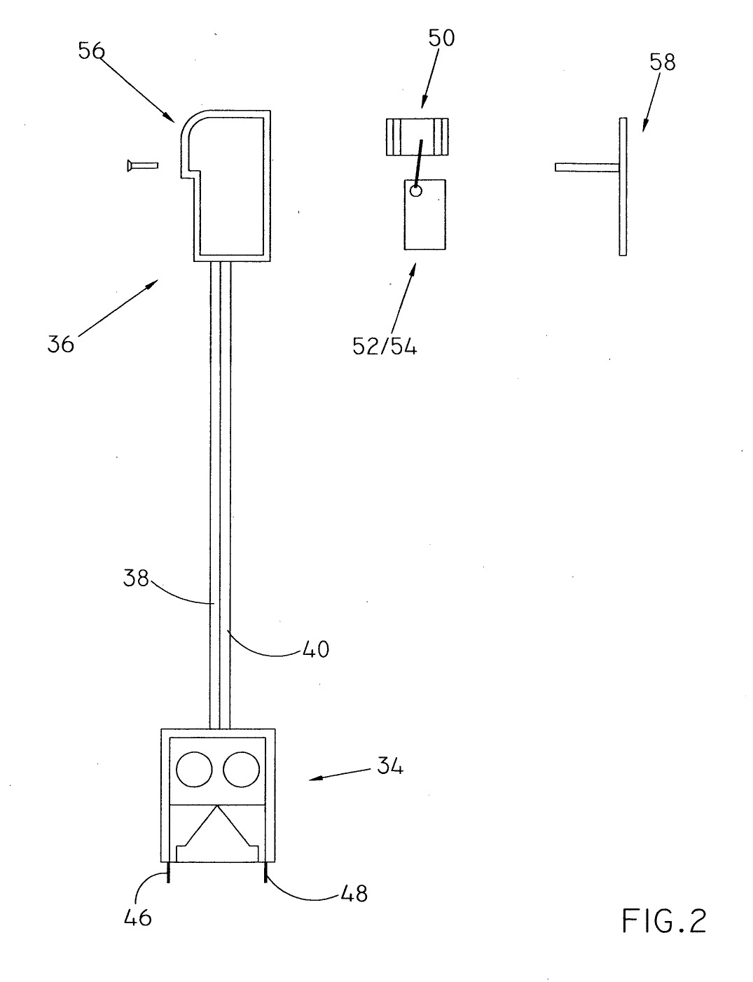

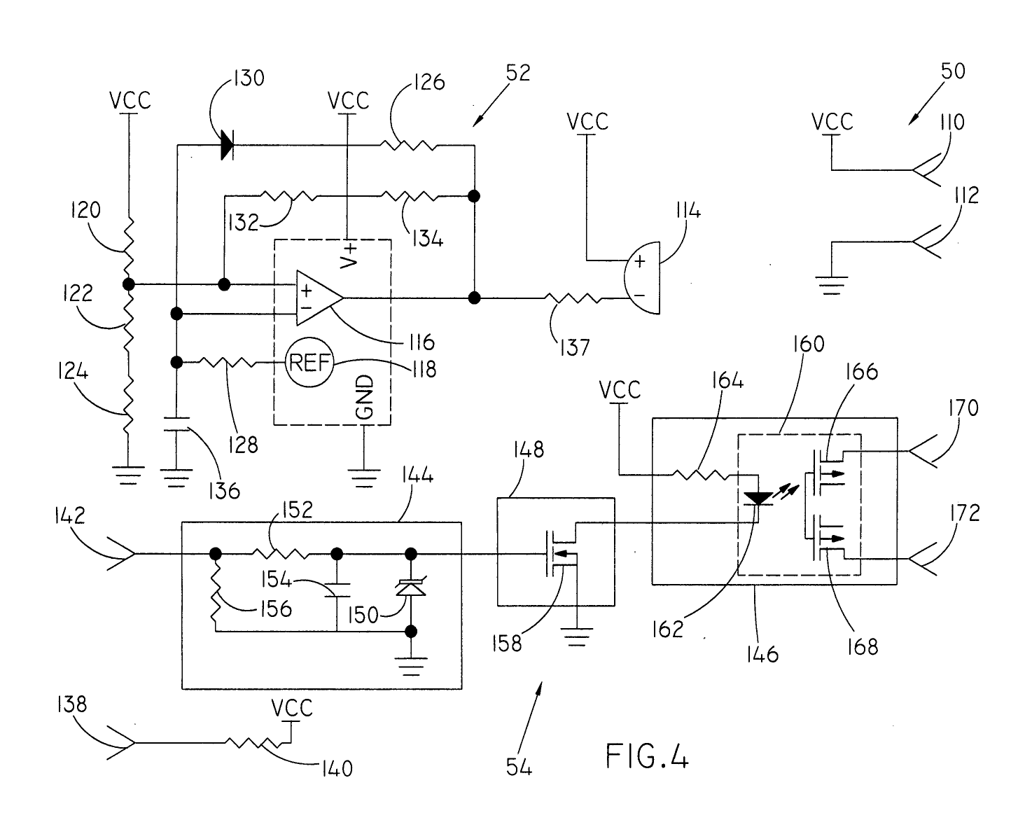

As shown in FIGS. 2 and 4, the condensate sensor 34 comprises a first condensate sensing element or probe 46 and a second condensate sensing element or probe 48 coupled or connected to the control device 36 that comprises a battery power source, low battery indicator or alarm and control relay or switch generally indicated as 50, 52 and 54 respectively enclosed within a housing and a back plate generally indicated as 56 and 58 respectively.

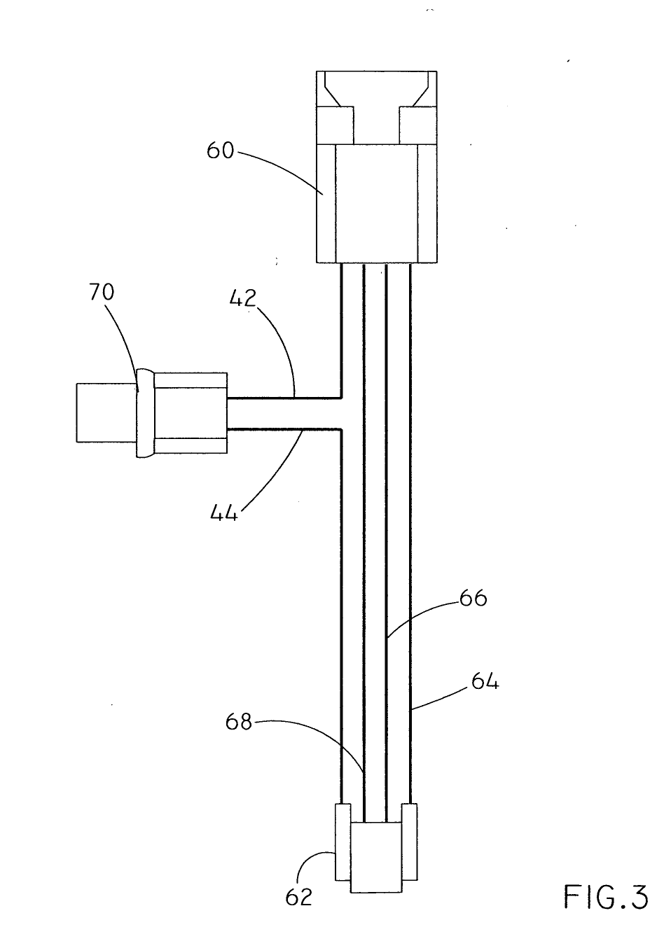

FIG. 3 depicts a coupling harness comprising a fault sensor interface connector 60 and an air handler controls system interface connector 62 connected to the fault sensors or thermistors 26 and 28 and the air handler control system 24 by conductors 64, 66 and 68, and connected to a control device interface connector 70 coupled between the fault sensor or thermistor 28 and the air handler control system 24 by the conductors 42 and 44 respectively to operatively integrate or couple the control device 36 with the existing air conditioning system without compromising the integrity of the communication and control links 30 and 31 between the remote air handler 12 and the compressor 10.

FIG. 4 is a schematic diagram of the control system 36 of the present invention comprising the isolated external battery power source 50, the low battery indicator or alarm 52 and the control relay or switch or circuit 54.

The relay or switch 54 is powered by the isolated external battery power source 50 connected between a positive voltage socket or connector 110 and a ground or negative voltage socket or connector 112.

The low battery indicator or alarm 52 comprises a buzzer or audible alarm 114 coupled to the output of a comparator 116 coupled to the isolated external battery power source 50 and a fixed reference voltage 118 to generate a low battery alarm indicator signal when the voltage from the isolated external battery power source 50 reaches a minimum predetermined voltage such as 1.2 volts. The low battery indicator or alarm 52 further includes scaling resistors 120, 122 and 124, timing resistors 126 and 128 and timing diode 130, feedback resistors 132 and 134, capacitor 136, and resistor 137.

A positive voltage socket or connector 138 is coupled between the isolated external battery power source 50 through a current limiting resistor 140 and the first condensate sensing probe 46 through the first sensor signal conductor or line 38. A second socket or connector 142 is coupled between the solid state relay/switch circuit described hereinafter and the second condensate sensing probe 48 through the second sensor signal conductor or line 40.

The solid state control circuit or control device comprises an input stage generally indicated as 144 coupled to an output stage generally indicated as 146 by an intermediate stage generally indicated as 148.

The input stage 144 comprises a voltage limiting zeneer diode 150, resistor 152 and filter capacitor 154 combination and a resistor 156 to hold the voltage low and configured to receive current through socket or connector 142 when the level of condensate accumulated in the condensate drain pan 20 is such that the tips of first condensate sensing probe 46 and the second condensate sensing probe 48 are submersed in the condensate creating an impedance completing the circuit causing current to flow through the input stage 144. The intermediate control stage 148 comprises a field effect transistor 158 coupled to the output of the input stage 144 such that when current flows through the input stage 144 the field effect transistor 158 is turned on.

The output stage 146 comprises an output control signal circuit 162 coupled to the condensate sensor 34 through the input stage 144 and the intermediate stage 148 and an output control signal generator circuit 166/168 coupled between the air handler control 24 through the fault sensor or thermistor 28. More specifically, the output stage 146 comprises a opto isolator or opto coupler 160 including a light emitting diode (LED) 162 coupled between positive voltage VCC through a resistor 164 and the field effect transistor 158 of the intermediate stage 148, and a pair of field effect transistors 166 and 168 coupled to the fault sensor or thermistor 28 and the air handler control system 24 through sockets or connectors 170 and 172, control signal conductor or line 42 and control signal conductor or line 44 such that when field effect transistor 158 of intermediate stage 148 is conducting LED 162 of opto isolator or opto coupler 160 is energized driving the field effect transistors 166 and 168 to generate the condensate level signal fed to the fault sensor or thermistor 28 causing the air handler electronic system 24 to generate the fault control signal fed to the compressor 10 through the air handler power/communications conductors or lines 30 and 31 shutting down the compressor 10 when the condensate level reaches a predetermined level in the condensate drain pan 20 as sensed by the first condensate element or sensing probe 46 and the second condensate sensing element or probe 48 thus completing a circuit to actuate the fault sensor or thermistor 28.

The condensate can be drained or pumped from the condensate drain pan 20 through the condensate drain conduit 22.

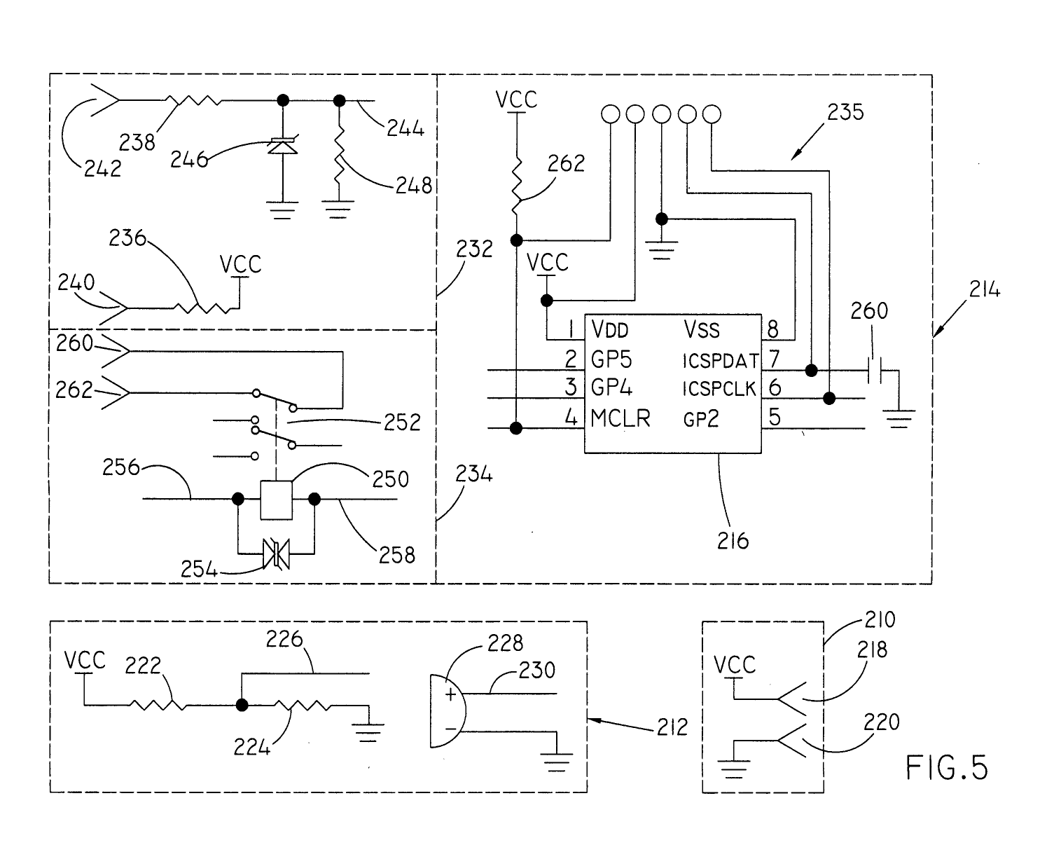

FIG. 5 is a schematic diagram of an alternate embodiment of the control system 36 comprising a battery power source 210, a low battery indicator or alarm 212, a control device generally indicated as 214 including a microprocessor 216.

The control device 214 and microprocessor 216 are powered by the battery power source 210 connected between a positive voltage socket or connector 218 and a ground or negative voltage socket or connector 220.

The low battery indicator or alarm 212 also powered by the battery power source 210 comprises resistors 222 and 224 forming a voltage divider coupled to an analog to digital convertor (A/D converter) within the microprocessor 216 by a conductor or line 226 to monitor the battery status or life in combination with an audible or visual alarm indicator 228 coupled to the microprocessor 210 by a conductor or line 230.

The control device 214 comprises an input stage generally indicated as 232 coupled to an output stage generally indicated as 234 by the microprocessor 216 or an intermediate stage generally indicated as 235.

The input stage or control signal circuit 232 comprises resistors 236 and 238 coupled to the first condensate sensing element or probe 46 and the second condensate sensing element or probe 48 respectively by connectors or lines 240 and 242 and coupled to the A/D converter within the microprocessor 216 by a conductor or line 244. A voltage limiting zeneer diode 246 and a resistor 248 are coupled to ground to provide protection to the input stage or signal control circuit 232. When the condensate within the condensate drain pan 20 is below the predetermined level the circuit is open. However when the condensate reaches the predetermined level within the condensate drain pan 20 the condensate creates an impedance between the first condensate sensing element or probe 46 and the second condensate sensing element or probe 48 presenting a voltage to the A/D converter within the microprocessor 216.

The output stage or control signal generator circuit or control switch assembly 234 comprises a resettable latching relay 250, including a double pole switch 250 and a dual zeneer diode combination 254 coupled to the microprocessor 216 by conductors or lines 256 and 258 operable in one of either of two states depending on the polarity of the last energizing pulse from the input stage or control signal circuit 232. Sockets 260 and 262 are coupled to the fault sensor 28 and the air handler control system 24 by the conductors or lines 42 and 44 respectively.

The audible or visual alarm 228 such as a piezo sounder driven by the microcontroller 216 will generate a low battery indicator or signal when the battery power source 210 reaches a minimum predetermined voltage.

A capacitor 260 is a timing component used in conjunction with the microcontroller 216.

The microprocessor 216 operates on a predetermined sampling cycle such as 1000 ms sampling cycle. Specifically, during each predetermined sampling cycle of 1000 ms the microcontroller 216 performs two (2) separate functions or conversion samplings (factors or parameters) during a predetermined sampling period such as 10 ms to determine if the condensate level within the condensate drain pan 20 has reached the predetermined level and whether or not the charge or voltage of the battery power source 210 has reached the predetermined minimum voltage or charge.

An impedance between the first condensate sensing element or probe 46 and the second condensate sensing element or probe 48 is sensed when the condensate level within the condensate drain pan 20 reaches the predetermined condensate level. Both the impedance and the battery voltage level of the battery power source 210 are sampled multiple times during each 10 ms sampling period. For example, each of the two (2) factors or parameters is sampled five (5) times during each 10 ms sampling period. If the respective multiple samples detect that the condensate in the condensate drain pan 20 has reached the predetermined condensate level the impedance completes the circuit to generate the condensate sensor signal fed to the microprocessor 216 that includes logic or circuitry to generate the condensate level control signal fed through the output control signal circuit or control switch assembly 234 to the air handler control system 24.

Similarly, if a low battery is detected or sensed during any of the respective multiple samples during a duty cycle, a low battery signal is created to activate the audible or visual alarm indicator 228.

During the remaining 990 ms of each sampling cycle, the control device 214 including the microprocessor 216 is in a deep sleep mode. That is, if condensate is detected the latching relay is pulsed to effect shutdown of the compressor 10. When the condensate is removed the latching relay is pulsed to effect normal operation of the compressor 10.

Furthermore, due the pulsed nature of the latching relay power consumption is extremely low, preserving the charge and extending the life of the battery power source 210.

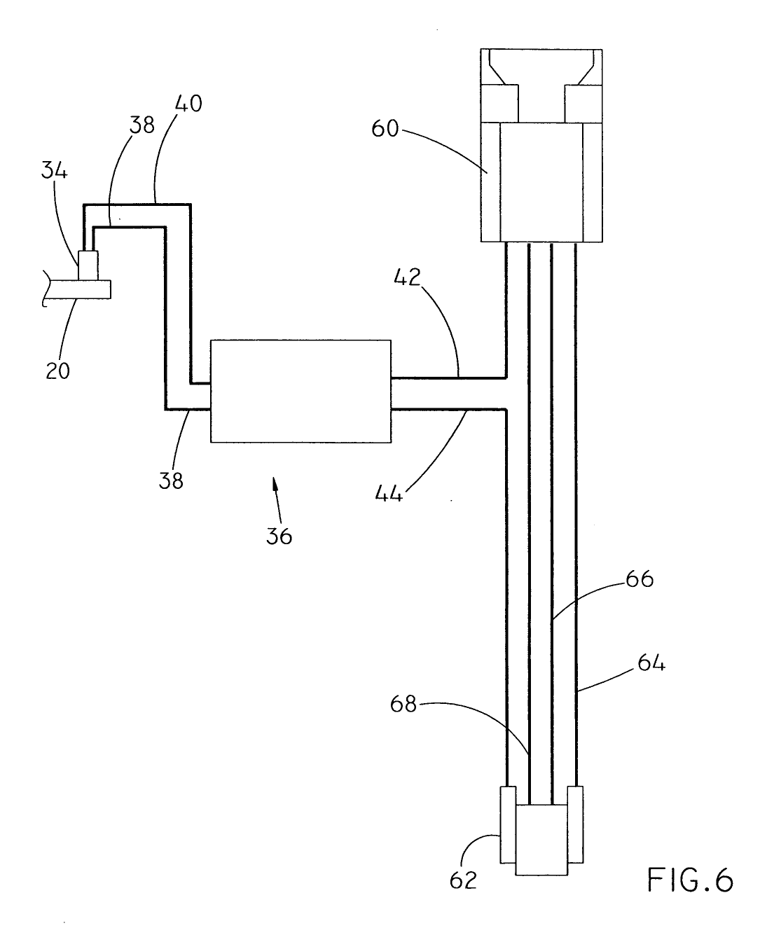

FIG. 6 depicts an alternate embodiment of the coupling harness comprising a control sensor interface connector 60 and an air handler control system interface connector 62 connected to the control sensors or thermistors 26 and the air handler control system 24 by conductors 64, 66 and 68, and connected to the control device 36 by the conductors 42 and 44 to operatively integrate or couple the control system 36 with an existing air conditioning system without compromising the integrity of the communication and control links 30 and 31 between the remote air handler 12 and the compressor 10.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A control system to selectively control the operation of the compressor of an air conditioning system including at least one remote evaporator operatively coupled to the compressor to receive refrigerant therethrough, an air handler control system including a fault sensor to monitor the operation of the remote evaporator and to selectively generate a fault signal, and logic or circuitry to receive the fault signal from the fault sensor and to generate a fault control signal fed to the compressor to turn-off the compressor when a predetermined operating condition exists at the remote evaporator and a condensate drain pan to collect condensate from the remote evaporator, said control system comprising a condensate sensor disposed to sense condensate in the condensate drain pan at a predetermined level and to generate a condensate level signal fed to a control device coupled between said condensate sensor and the fault sensor of the air handler control system including logic or circuitry to generate a condensate level control signal in response to said condensate level signal and fed to the fault sensor to generate the fault signal causing the air handling control system to generate the fault control signal to turn-off the compressor when condensate within the condensate drain pan reaches the predetermined level.

2. The control system of claim 1 further including a battery power source to supply operating power to said control system.

3. The control system of claim 2 wherein said control device comprises a solid state relay to generate said condensate level control signal.

4. The control system of claim 3 wherein said solid state relay comprises an output signal control coupled to said condensate sensor to receive said condensate level signal from said condensate sensor and an output signal control generator to generate said condensate level control signal in response to said condensate level signal coupled between said output signal control and the fault sensor to feed said condensate level control signal thereto.

5. The control system of claim 4 wherein said output signal control comprises an opto isolator and said output signal control generator comprises at least one field effect transistor such that said opto isolator drives said field effect transistor to generate said condensate level control signal fed to the fault sensor to generate the operating control signal fed to the compressor shutting down the compressor when the condensate level reaches a predetermined level in the condensate drain pan sensed by said condensate sensor.

6. The control system of claim 5 wherein said control device further includes an input stage coupled to said output stage by an intermediate control stage.

7. The control system of claim 6 wherein said intermediate control stage comprises a field effect transistor coupled to said input stage such that when condensate in the condensate drain pan reaches said predetermined level current flows through said input stage is turned on to said field effect transistor to energize said field effect transistors of said output stage.

8. The control system of claim 7 wherein the input stage comprises voltage limiting zeneer diode, resistor and filter capacitor combination and resistor to hold the voltage low configured to receive current when the level of condensate within the condensate drain pan is such that when said condensate sensor is submersed in the condensate current flows through said input stage.

9. The control system of claim 2 further including a low battery alarm to signal when the power supplied by said battery receives a minimum value.

10. The control system of claim 9 wherein said low battery alarm comprises audible alarm coupled to the output of a comparator coupled to said battery and a fixed reference voltage to generate a low battery indication when the voltage from the battery power source reaches a minimum predetermined voltage.

11. The control system of claim 1 further including a coupling harness comprising a control sensor interface connector and an electronics system interface connector coupled to said control sensor and the electronic system and a control device interface connector coupled between said control sensor and the electronics system to operatively integrate said control system into an existing mini-split conditioning system without compromising the integrity of the communication and control links between the compressor and the air handler.

12. The control system of claim 1 wherein said condensate sensor comprises a first condensate sensing element and a second condensate element disposed to create a potential therebetween when the condensate in the condensate drain pan reaches said predetermined level.

13. The control system of claim 1 further including a coupling harness comprising a control sensor interface connector and an air handler control system to operatively integrate said control system into an existing conditioning system without compromising the integrity of the communication and control links between the compressor and the control system.

14. The control system of claim 2 wherein said control device comprises an input control signal circuit coupled between said condensate sensor and a microprocessor including an analog to digital convertor to convert said condensate sensor signal to digital form and an output control signal circuit or control switch assembly coupled between said microprocessor and said fault sensor to receive said condensate sensor signal and generate said condensate control signal fed to the fault sensor.

15. The control system of claim 14 wherein said input control signal circuit is coupled between said first condensate sensing element or probe and said second condensate sensing element or probe and said A/D converter within said microprocessor such that when the condensate within the condensate drain pan is below said predetermined level said output control signal circuit is open and when the condensate reaches said predetermined level within the condensate drain pan the condensate creates an impedance between said first condensate sensing element or probe and said second condensate sensing element or probe presenting a voltage to said A/D converter within said microprocessor.

16. The control system of claim 15 wherein said output control signal generator circuit or control switch assembly comprises a latch coupled to said microprocessor operable in one of either of two states depending on the polarity of the last energizing pulse from said output control signal circuit.

17. The control system of claim 14 wherein said microprocessor operates on a predetermined sampling cycle to separately sample the level of condensate in the condensate drain pan and voltage level in the battery power source.

18. The control system of claim 17 wherein said microprocessor samples the condensate level and voltage level during a sampling period for less than said predetermined sampling cycle.

19. The control system of claim 18 wherein the condensate level and the voltage level are sampled multiple times during said sampling period to generate said condensate sensor signal fed to the microprocessor that includes logic or circuitry to generate said condensate level control signal fed through said output control signal circuit or control switch assembly to said fault sensor when condensate is sensed during each sample within a sampling period or if a low battery is detected or sensed during the multiple samples during a duty cycle, a low battery signal is created to activate the audible or visual alarm indicator.

20. The control system of claim 16 wherein said latch comprises a resettable latch is pulsed to shutdown the compressor when condensate is sensed by said condensate sensor, condensate is removed and said resettable latch is pulsed to effect normal operation of the compressor.

21. A control system to selectively control the operation of the compressor of an air conditioning system including at least one remote evaporator operatively coupled to the compressor to receive refrigerant therethrough, an air handler control system including a fault sensor to monitor the operation of the remote evaporator and to selectively generate a fault signal, and logic or circuitry to receive the fault signal from the fault sensor and to generate a fault control signal fed to the compressor to turn-off the compressor when a predetermined operating condition exists at the remote evaporator and a condensate drain pan to collect condensate from the remote evaporator, said control system comprising a condensate sensor disposed to sense condensate in the condensate drain pan at a predetermined level and to generate a condensate level signal fed to a control device coupled between said condensate sensor and the fault sensor of the air handler control system including logic or circuitry to generate a condensate level control signal in response to said condensate level signal and fed to the fault sensor to generate the fault signal causing the air handling control system to generate the fault control signal to turn-off the compressor when condensate within the condensate drain pan reaches the predetermined level wherein said control device comprises an input control signal circuit coupled between said condensate sensor and a microprocessor including an analog to digital convertor to convert said condensate sensor signal to digital form and an output control signal circuit or control switch assembly coupled between said microprocessor and said fault sensor to receive said condensate sensor signal and generate said condensate control signal fed to the fault sensor and wherein said microprocessor operates on a predetermined sampling cycle to sample the level of condensate in the condensate drain pan and sample the condensate during a sampling period for less than said predetermined sampling cycle, the condensate level is sampled multiple times during said sampling period to generate said condensate sensor signal fed to the microprocessor that includes logic or circuitry to generate said condensate level control signal fed through said output control signal circuit or control switch assembly to said fault sensor when condensate is sensed during each sample within a sampling period during the multiple samples during a duty cycle.

22. A control system to selectively control the operation of the compressor of an air conditioning system including at least one remote evaporator operatively coupled to the compressor to receive refrigerant therethrough, an air handler control system including a fault sensor to monitor the operation of the remote evaporator and to selectively generate a fault signal, and logic or circuitry to receive the fault signal from the fault sensor and to generate a fault control signal fed to the compressor to turn-off the compressor when a predetermined operating condition exists at the remote evaporator and a condensate drain pan to collect condensate from the remote evaporator, said control system comprising a condensate sensor disposed to sense condensate in the condensate drain pan at a predetermined level and to generate a condensate level signal fed to a control device coupled between said condensate sensor and the fault sensor of the air handler control system including logic or circuitry to generate a condensate level control signal in response to said condensate level signal and fed to the fault sensor to generate the fault signal causing the air handling control system to generate the fault control signal to turn-off the compressor when condensate within the condensate drain pan reaches the predetermined level wherein said control device comprises an input control signal circuit coupled between said condensate sensor and a microprocessor including an analog to digital convertor to convert said condensate sensor signal to digital form and an output control signal circuit or control switch assembly coupled between said microprocessor and said fault sensor to receive said condensate sensor signal and generate said condensate control signal fed to the fault sensor wherein said microprocessor operates on a predetermined sampling cycle to sample the level of condensate in the condensate drain pan wherein the condensate level is sampled multiple times during said sampling period to generate said condensate sensor signal fed to the microprocessor that includes logic or circuitry to generate said condensate level control signal fed through said output control signal circuit or control switch assembly to said fault sensor when condensate is sensed during each sample within a sampling period during the multiple samples during a duty cycle wherein said microprocessor operates on a predetermined sampling cycle to separately sample the level of condensate in the condensate drain pan and the voltage level in a battery power source wherein the condensate level and the voltage level are sampled multiple times during said sampling period to generate said condensate sensor signal fed to the microprocessor that includes logic or circuitry to generate said condensate level control signal fed through said output control signal circuit or control switch assembly to said fault sensor when condensate is sensed during each sample within a sampling period or if a low battery is detected or sensed during the multiple samples during a duty cycle a low battery signal is created to activate the audible or visual alarm indicator.
